(19) United States
(12) Patent Application Publication
(10) Pub. No.: US 2007/0080907 A1
(43) Pub. Date: Apr. 12, 2007

(54) DISPLAY DEVICE AND DRIVING METHOD THEREOF

(75) Inventors: Kyong-Tae PARK, Uijeongbu-si (KR); Si-Duk SUNG, Seoul (KR); Nam-Deog KIM, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/539,412

(22) Filed: Oct. 6, 2006

(30) Foreign Application Priority Data
Oct. 11, 2005 (KR) 10-2005-0095531

(51) Int. Cl. G09G 3/30

(52) U.S. Cl. 345/76

(57) ABSTRACT

A display device includes a display panel including a plurality of scanning signal lines, a plurality of data lines and a plurality of pixels; a scan driver for applying a scanning signal to the scanning signal line; and a data driver for generating a data voltage including a normal data voltage and a reverse bias voltage, sequentially applying the normal data voltage to all pixels during a first period, and then applying a reverse bias voltage to all pixels during a second period which is shorter than the first period. Each pixel includes a switching transistor which is connected to one of the scanning signal lines and one of the data lines, a driving transistor electrically connected to the switching transistor, and an organic light emitting diode which is connected to the driving transistor.

This application claims priority to Korean Patent Application No. 10-2005-0095531, filed on Oct. 11, 2005, and all the benefits accruing therefrom under 35 U.S.C. § 119, the contents of which in its entirety are herein incorporated by reference.

### BACKGROUND OF THE INVENTION

(a) Field of the Invention

The present invention relates to a display device.

(b) Description of the Related Art

Recently, flat panel displays, which are beginning to replace cathode ray tubes (“CRTs”), have been actively researched. Particularly, organic light emitting diode (“OLED”) displays have excellent luminance characteristics and viewing angle characteristics, and therefore they have been spotlighted as a future generation flat panel display.

In general, in an active type of flat panel display, a plurality of pixels are arranged in a matrix shape and an image is displayed using a plurality of thin film transistors (“TFTs”), each TFT controlling the intensity of light emitted by an individual pixel according to luminance information provided from an external source.

An OLED display is a display device for displaying an image by electrically exciting a phosphorous organic material to emit light. Because the organic light emitting diode display emits light on its own and has a low power consumption and a fast pixel response speed, it is easy to display high quality motion pictures.

The organic light emitting diode display includes an OLED and a thin film transistor (“TFT”) for driving the diode. The TFT may be a poly silicon TFT, an amorphous silicon TFT, or other type of TFT depending on the kind of active layer used in its manufacture. Because the OLED display employing the poly silicon TFT has various merits, it is generally widely used. However, poly silicon TFTs have a complicated manufacturing process which increases the cost associated with displays which utilize them. Furthermore, it is difficult for the OLED display utilizing poly silicon TFTs to obtain large display sizes due to the complicated manufacturing process. The more complicated the process, the more likely it is that a defect may be produced.

On the other hand, in the OLED display employing an amorphous silicon TFT, it is comparatively easy to obtain a large display size as there are relatively fewer manufacturing processes than with the OLED display employing a poly silicon TFT. However, one aspect of the amorphous silicon TFT is that it continuously supplies a current to the organic light emitting diode, and as a result a threshold voltage (or turn-on voltage) of the amorphous silicon TFT degrades over time. Eventually the increased threshold voltage causes a non-uniform current to flow to the organic light emitting diode when the same data voltage is applied, so that the picture quality of the OLED display is degraded.

### BRIEF SUMMARY OF THE INVENTION

The present invention provides a display device having the advantage of preventing degradation in picture quality by preventing a change in a threshold voltage of an amorphous silicon TFT.

An exemplary embodiment of the present invention provides a display device including; a display panel including a plurality of scanning signal lines, a plurality of data lines, and a plurality of pixels which are connected to the scanning signal lines and the data lines and which are arranged in a plurality of lines and rows to form a matrix shape, for displaying an image, a scan driver for applying a scanning signal to the scanning signal line, and a data driver for generating a data voltage including a normal data voltage and a reverse bias voltage, sequentially applying the normal data voltage to substantially all of the pixels during a first period, and then applying a reverse bias voltage to substantially all of the pixels during a second period. Each pixel includes a switching transistor which is connected to one of the scanning signal lines and one of the data lines, a driving transistor which is electrically connected with the switching transistor, and an organic light emitting diode which is connected to the driving transistor.

According to an exemplary embodiment of the present invention, the reverse bias voltage may have a magnitude which can turn off the driving transistor.

According to one exemplary embodiment, the reverse bias voltage may be simultaneously applied to two or more of the lines of pixels.

According to one exemplary embodiment the length of the first period may be one or more times that of the second period.

The length of the first period may be one or more times that of the second period.

Another exemplary embodiment of the present invention provides a driving method of an organic light emitting diode display including a plurality of pixels which are arranged in a plurality of lines and rows to form a matrix shape, each pixel including a switching transistor which is connected to a scan signal line and a data line, a driving transistor which is electrically connected with the switching transistor, and an organic light emitting diode which is connected to the driving transistor, the method including: sequentially applying a normal data voltage to the pixel; and sequentially applying a reverse bias voltage to the pixel, wherein the reverse bias voltage is simultaneously applied to two or more of the lines of pixels.

According to an exemplary embodiment of the present invention, the reverse bias voltage has a magnitude which can turn off the driving transistor.

According to an exemplary embodiment of the present invention the length of time in which the normal data voltage is applied may be one or more times of the length of time in which the reverse bias voltage is applied.

### BRIEF DESCRIPTION OF THE DRAWINGS

FIG. 1 is a block diagram of an exemplary embodiment of an OLED display according to the present invention;

FIG. 2 is an equivalent circuit schematic diagram of an exemplary embodiment of one pixel of the OLED display according to the present invention;

FIG. 3 is a cross-sectional view of an exemplary embodiment of an organic light emitting diode and a driving transistor of the exemplary embodiment of one pixel of the OLED display shown in FIG. 2;

FIG. 4 is a schematic diagram of an exemplary embodiment of an organic light emitting diode of the OLED display according to the present invention;

FIG. 5 is a block diagram illustrating an exemplary embodiment of a data driver of the exemplary embodiment of an OLED display shown in FIG. 1;

FIG. 6 is a waveform diagram illustrating an exemplary embodiment of an input and output signal of the exemplary embodiment of a data driver shown in FIG. 5;

FIG. 7 is a waveform diagram of an exemplary embodiment of the operation of an OLED display according to the present invention;

FIG. 8 is a schematic diagram illustrating a screen of the exemplary embodiment of the OLED display which is displayed according to the driving method illustrated in FIG. 7;

FIG. 9 is a waveform diagram of another exemplary embodiment of the operation of an OLED display according to the present invention; and

FIG. 10 is a schematic diagram illustrating a screen of the exemplary embodiment of the OLED display which is displayed according to the operation illustrated in FIG. 9.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

Now, an exemplary embodiment of a display device and a driving method thereof according to the present invention will be described in detail with reference to the accompanying drawings.

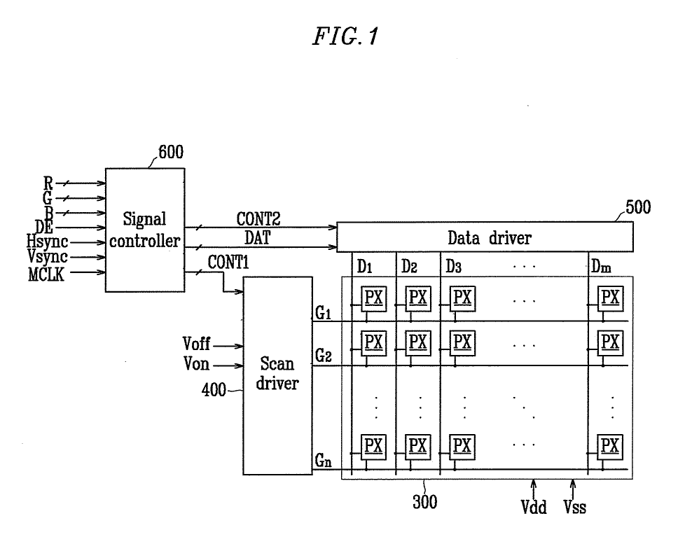

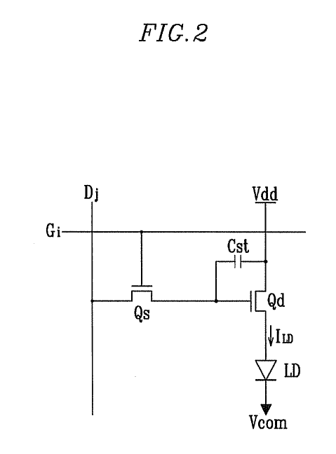

FIG. 1 is a block diagram of an exemplary embodiment of an OLED display according to the present invention, and FIG. 2 is an equivalent circuit schematic diagram of an exemplary embodiment of one pixel of the OLED display according to the present invention.

Referring to FIG. 1, the exemplary embodiment of an OLED display according to the present invention includes a display panel 300, a scan driver 400, a data driver 500 and a signal controller 600.

The display panel 300 includes a plurality of display signal lines G₁-Gₙ and D₁-Dₘ, a plurality of driving voltage lines (not shown) and a plurality of pixels PX, which are connected thereto and arranged in substantially a matrix shape as seen from an equivalent circuit view.

The display signal lines G₁-Gₙ and D₁-Dₘ include a plurality of scanning signal lines G₁-Gₙ, which transfer scanning signals Vg₁-Vgₙ, and a plurality of data lines D₁-Dₘ, which transfer a data voltage. The scanning signal lines G₁-Gₙ extend in approximately a row direction and are separated from, and are substantially parallel to, each other. The data lines D₁-Dₘ extend in approximately a column direction and are separated from, and are substantially parallel to, each other.

A driving voltage line transfers a driving voltage Vdd to each pixel PX.

Referring to FIG. 2, each pixel PX, for example a pixel PX, which is connected to the scanning signal line Gᵢ and the data line Dⱼ, includes an organic light emitting diode LD, a driving transistor Qd, a capacitor Cst and a switching transistor Qs.

In the driving transistor Qd, an input terminal is connected to a driving voltage Vdd and one side of the capacitor Cst, an output terminal is connected to the organic light emitting diode LD, and a control terminal is connected to an output terminal of the switching transistor Qs and the opposite side of the capacitor Cst.

In the switching transistor Qs, an input terminal is connected to the data line Dⱼ and an output terminal is connected to the control terminal of the driving transistor Qd and one side of the capacitor Cst. The switching transistor Qs receives a scanning signal from the scanning signal line Gᵢ through its control terminal, and performs an on/off operation.

The capacitor Cst is connected between the control terminal and the input terminal of the driving transistor Qd. Such capacitor Cst is charged and maintains a charge corresponding to a difference between a data voltage and a driving voltage Vdd from the switching transistor Qs.

The organic light emitting diode LD is composed of an organic light emitting diode (“OLED”), and an anode thereof is connected to the output terminal of the driving transistor Qd and a cathode thereof is connected to a common voltage Vcom. The organic light emitting diode LD receives a driving current I_{LD} from the output terminal of the driving transistor Qd and emits light of a variable intensity depending on a magnitude of the driving current I_{LD}. The magnitude of the driving current I_{LD} depends on a magnitude of a voltage between the control terminal and the output terminal of the driving transistor Qd.

According to the present exemplary embodiment, the switching transistor Qs and the driving transistor Qd are each composed of an n-channel field effect transistor (“FET”) which is made of amorphous silicon or poly silicon. However alternative exemplary embodiments include configurations where the transistors Qs and Qd may be each composed of a p-channel FET. In such an alternative exemplary embodiment, since the p-channel FET and the n-channel FET are complementary to each other, an operation, a voltage and a current of the p-channel FET are opposite to those of the n-channel FET.

Each pixel PX may include other transistors (not shown) besides the switching transistor Qs and the driving transistor Qd. In an exemplary embodiment where other transistors are used, the driving transistor Qd may have an indirect electrical connection relationship with the switching transistor Qs.

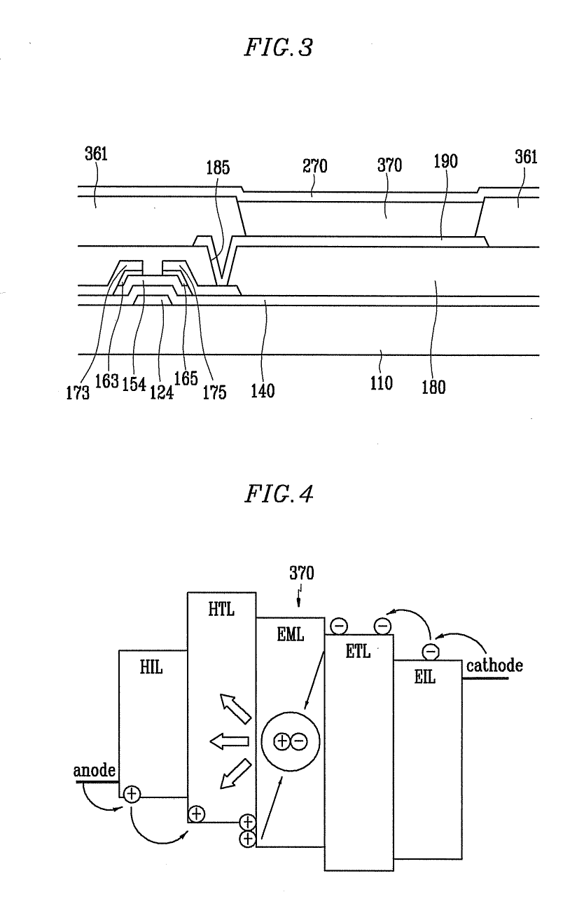

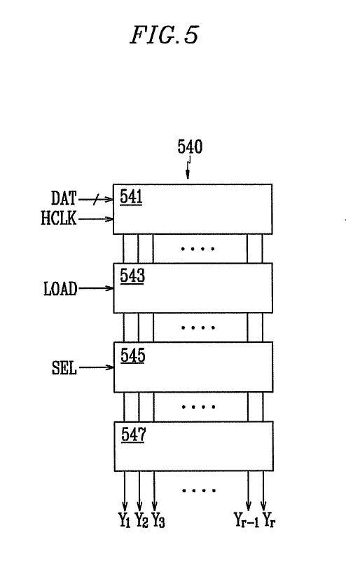

Now, a detailed structure of the driving transistor Qd and the organic light emitting diode LD of the organic light emitting diode display shown in FIG. 2 win be described in detail with reference to FIGS. 3 and 4.

FIG. 3 is a cross-sectional view of an exemplary embodiment of an organic light emitting diode and a driving transistor of the exemplary embodiment of one pixel of the OLED display shown in FIG. 2. FIG. 4 is a schematic diagram of an exemplary embodiment of an organic light emitting diode of the OLED display according to the present invention.

A control electrode 124 is formed on the insulation substrate 110. In one exemplary embodiment, the control electrode 124 is made of an aluminum metal such as aluminum (Al) or an aluminum alloy, a silver metal such as silver (Ag) or a silver alloy, a copper metal such as copper (Cu) or a copper alloy, a molybdenum metal such as molybdenum (Mo) or a molybdenum alloy, chromium (Cr), titanium (Ti), thallium (Ta), or other similar substances. However, alternative exemplary embodiments include configurations where the control electrode 124 may have a multi-layered structure including two conductive layers (not shown) which have different physical properties. In such an alternative exemplary embodiment one conductive layer may be made of a metal having low resistivity, exemplary embodiments of which include aluminum metals, silver metals, copper metals, or other similar substances in order to reduce a signal delay or a voltage drop. The other conductive layer in such an alternative exemplary embodiment may be made of a material such as molybdenum metals, chromium, titanium, thallium, or other similar substances, which has excellent physical, chemical, and electrical contact characteristics with other materials, specifically indium tin oxide (“ITO”) and indium zinc oxide (“IZO”). Exemplary embodiments of such a combination may include a chromium lower layer and an aluminum (or Al alloy) upper layer, and an aluminum (or Al alloy) lower layer and a molybdenum (or Mo alloy) upper layer. However, the control electrode 124 may be made of various metals or electric conductors and still be within the scope of the present invention. The control electrode 124 is inclined to a surface of the substrate 110 and an inclination angle thereof is from about 30° to about 80°.

An insulating layer 140, one exemplary embodiment of which is made of silicon nitride (“SiNx”), is formed on the control electrode 124.

A semiconductor 154, exemplary embodiments of which may be made of hydrogenated amorphous silicon (abbreviated to a-Si), polycrystalline silicon, or other similar substances, is formed on the insulating layer 140.

A pair of ohmic contacts 163 and 165, exemplary embodiments of which may be made of a material such as n+ hydrogenated amorphous silicon in which silicide or an n-type impurity is doped with high concentration, is formed on the semiconductor 154.

Side surfaces of the semiconductor 154 and the ohmic contacts 163 and 165 are inclined to a surface of the substrate 110, and an inclination angle thereof is about 30° to about 80°.

An input electrode 173 and an output electrode 175 are formed on the ohmic contacts 163 and 165 and the insulator film 140. Exemplary embodiments of the input electrode 173 and the output electrode 175 are made of a metal such as chromium and molybdenum, and a refractory metal such as thallium and titanium. Alternative exemplary embodiments include configurations in which the input electrode 173 and the output electrode 175 may have a multi-layered structure including a lower layer (not shown) such as a refractory metal and a low resistance upper layer (not shown) which is positioned on the lower layer.

An exemplary embodiment of the alternative multilayered structure includes, for example, a dual layer of a chromium or molybdenum (or Mo alloy) lower layer and an aluminum upper layer, and a triple layer of a molybdenum (or Mo alloy) lower layer, an aluminum (or Al alloy) intermediate layer, and a molybdenum (or Mo alloy) upper layer. In the input electrode 173 and the output electrode 175, side surfaces thereof are also inclined to a surface of the substrate 110, and an inclination angle thereof is about 30° to about 80°.

The input electrode 173 and the output electrode 175 are separated from each other and positioned opposite one another with respect to the control electrode 124. The control electrode 124, the input electrode 173, the output electrode 175, and the semiconductor 154 constitute a driving transistor Qd, and the channel thereof is formed in the semiconductor 154 between the input electrode 173 and the output electrode 175.

The ohmic contacts 163 and 165 exist only between the lower semiconductor 154, the upper input terminal electrode 173, and the output terminal electrode 175, and they function to lower contact resistance therebetween. The semiconductor 154 is provided with a portion which is left exposed. That portion is left uncovered by the input electrode 173, the output electrode 175, and the ohmic contacts 163 and 165.

A passivation layer 180 is formed on the input electrode 173, the output electrode 175, the exposed portion of the semiconductor 154, the exposed side portions of the ohmic contacts 163 and 165, and the insulating layer 140. The passivation layer 180 is made of an inorganic insulator, an organic insulator, or other similar substances, and a surface thereof may be flat.

In the exemplary embodiment where the passivation layer is an inorganic insulator, it may include silicon nitride and silicon oxide. Exemplary embodiments of the organic insulator are photosensitive and have a dielectric constant of about 4.0 or less.

Alternative exemplary embodiments include the configuration where the passivation layer 180 may have a dual-layer structure including a lower inorganic layer and the upper organic layer. In such a configuration the lower layer is inorganic so as not to cause damage to the exposed portion of the semiconductor 154, and the upper layer is inorganic to provide excellent insulating characteristics.

A contact hole 185 exposing the output electrode 175 may be formed in the passivation layer 180.

A pixel electrode 190 is formed on the passivation layer 180. The pixel electrode 190 is physically and electrically connected to the output electrode 175 through the contact hole 185, and may be made of a transparent conductive material such as ITO or IZO and a metal having excellent a reflective surface such as aluminum or silver alloy.

A barrier 361 is also formed on the passivation layer 180. The barrier 361 defines an opening which is surrounded with the edge of the pixel electrode 190 like a bank, and is made of an organic insulating material or an inorganic insulating material.

An organic light emitting member 370 is formed on the pixel electrode 190 and is fixed within the opening defined by the barrier 361.

As shown in FIG. 4, the exemplary embodiment of an organic light emitting member 370 has a multi-layered structure. The exemplary embodiment of the light emitting member 370 includes an emission layer (“EML”) and accessory layers for improving the light emitting efficiency thereof. The accessory layers include an electron transport layer (“ETL”) and a hole transport layer (“HTL”) for adjusting the balance of electrons and holes, and an electron injecting layer (“EIL”) adjacent to the cathode and a hole injecting layer (“HIL”) adjacent to the anode for enhancing the injection of electrons and holes respectively. In alternative exemplary embodiments the accessory layers may be omitted.

The common electrode 270 to which a common voltage Vcom is applied is formed on the barrier 361 and the organic light emitting member 370. Exemplary embodiments of the common electrode 270 may be made of a reflective metal including calcium (Ca), barium (Ba), aluminum (Al), or silver (Ag), or other similar substances, or a transparent conductive material such as ITO and IZO.

In a top emission type of OLED display the pixel electrode 190 is made to be opaque and the common electrode 270 is made to be transparent. In a bottom emission type of OLED display the pixel electrode 190, and the insulation substrate are made to be transparent and the common electrode 270 is made to be opaque.

The pixel electrode 190, the organic light emitting member 370, and the common electrode 270 comprise the organic light emitting diode LD shown in FIG. 2. The pixel electrode 190 may become an anode and the common electrode 270 may become a cathode, or the pixel electrode 190 may become a cathode and the common electrode 190 may become an anode depending on the design choices in the construction of the circuit.

The organic light emitting diode LD may emit light of one of three primary colors depending on the materials used to construct the organic light emitting member 370. Exemplary embodiments of the primary colors include red, green and blue. When the primary colors are red, green and blue any desired color may be displayed using a mixture of the three primary colors.

Referring again to FIG. 1, the scan driver 400 applies scanning signals Vg1-Vgn which are formed with a combination of a high voltage Von which is connected to scanning signal lines G1-Gn to scanning signal lines G1-Gn, to turn on the switching transistor Qs, and a low voltage Voff which is connected to the scanning signal lines G1-Gn, to turn off the switching transistor Qs.

The data driver 500 is connected to data lines D₁-Dₘ to apply a data voltage to the data lines D₁-Dₘ. The data voltage includes a normal data voltage Vdat for displaying an image and a reverse bias voltage Vneg which can turn off a driving transistor Qd.

In one exemplary embodiment the scan driver 400 or the data driver 500 may be directly mounted on the display panel 300 as an integrated circuit (“IC”) driver chip, or in an alternative exemplary embodiment they may be mounted on a flexible printed circuit film (not shown), thereby being attached to the display panel 300 in a tape carrier package (“TCP”) form. Alternative exemplary embodiments include configurations where the scan driver 400 or the data driver 500, and the signal line and the transistor, etc., are formed on the display panel 300 as a system on panel (“SOP”).

The signal controller 600 controls the operation of the scan driver 400 and the data driver 500.

The signal controller 600 receives input control signals, for example a vertical synchronizing signal Vsync, a horizontal synchronizing signal Hsync, a main clock signal MCLK, a data enable signal DE, and other signals for controlling the input image signals R, G and B and the display thereof from an external graphics controller (not shown). The signal controller 600 processes the input video signals R, G and B depending on an operating condition of the display panel 300 and the input control signal, forms a scan control signal CONT1, a data control signal CONT2, and a processed digital image data signal DAT, then sends the scan control signal CONT1 to the scan driver 400, and sends the data control signal CONT2 and the processed digital image data DAT to the data driver 500.

The scan control signal CONT1 includes a scanning start signal STV (not shown) which instructs the scanning start of a high voltage Von and at least one clock signal which controls the output of the high voltage Von. The scan control signal CONT1 may also include an output enable signal OE (not shown) which limits a time duration of the high voltage Von.

The data control signal CONT2 includes a horizontal synchronization start signal STH (not shown) which carries data for one pixel line, a load signal LOAD which applies a corresponding data voltage to the data lines D₁-Dₘ, a selection signal SEL which selects whether any one of a normal data voltage Vdat and a reverse bias voltage Vneg is output, a data clock signal HCLK.

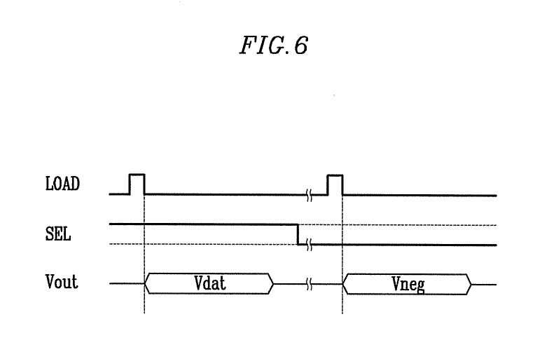

Now, the data driver 500 will be described in more detail with reference to FIGS. 5 and 6.

FIG. 5 is a block diagram illustrating an exemplary embodiment of a data driver of the exemplary embodiment of an OLED display shown in FIG. 1, and FIG. 6 is a waveform diagram illustrating an exemplary embodiment of an input and output signal of the exemplary embodiment of a data driver shown in FIG. 5.

The data driver 500 includes at least one data driver IC 540 shown in FIG. 5, and the data driver IC 540 includes a shift register 541, a latch 543, a digital-to-analog converter 545 and a buffer 547, which are sequentially connected.

If the shift register 541 receives a horizontal synchronization start signal STH (or a shift clock signal), it sequentially transfers digital image data DAT which are input depending on a data clock signal HCLK to the latch 543. In the alternative exemplary embodiment where the data driver 500 includes a plurality of data driver ICs 540 (not shown), each shift register 541 sends a shift clock signal (a carry out signal) to a shift register of a neighboring data driver IC after transferring all of the digital image data DAT, which it controls, to the latch 543.

The latch 543 stores the digital image data DAT which are sequentially received, and then sends the data to a digital-to-analog converter 545 depending on a load signal LOAD.

The digital-to-analog converter 545 receives the digital image data DAT and a selection signal SEL, converts the digital image data DAT to an analog data voltage Vout depending on the selection signal SEL, and sends the converted voltage to the buffer 547. As described above, the data voltage Vout includes a normal data voltage Vdat and a reverse bias voltage Vneg, where the reverse bias voltage Vneg has a polarity opposite to the polarity of the normal data voltage Vdat. That is, if the normal data voltage Vdat has a positive value, the reverse bias voltage Vneg has a negative value.

The buffer 547 sends a data voltage Vout from the digital-to-analog converter 545 through output terminals Y₁-Yᵣ [the number of output terminals and corresponding data lines should be the same, so “r” and “m” should be the same numbers] and maintains the voltage for a predetermined time. The output terminals Y₁-Yᵣ are connected to corresponding data lines D₁-Dₘ.

Referring to FIG. 6, the data driver IC 540 outputs a data voltage Vout which is synchronized with a falling edge of the load signal LOAD, and selects and sends the normal data voltage Vdat and the reverse bias voltage Vneg depending on the selection signal SEL. That is, the data driver IC 540 sends the normal data voltage Vdat to the output terminals Y₁-Yᵣ if the selection signal SEL is at a high level and sends the reverse bias voltage Vneg to the output terminals Y₁-Yᵣ if the selection signal SEL is at a low level. In an alternative exemplary embodiment, the data driver IC 540 may send the reverse bias voltage Vneg when the selection signal SEL is at a high level and may send the normal data voltage Vdat when the selection signal SEL is at a low level.

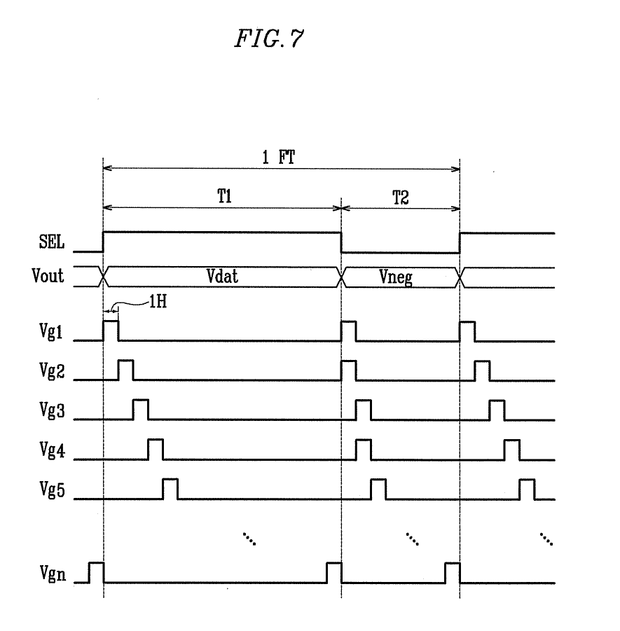

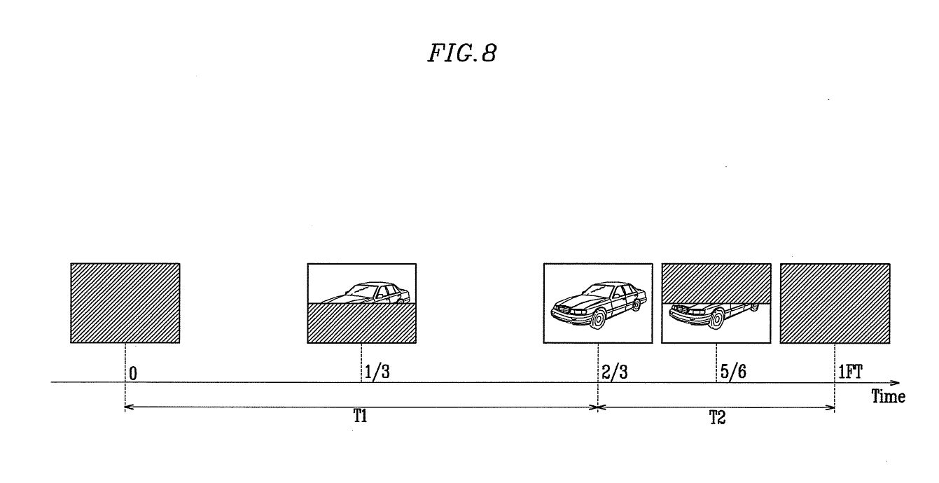

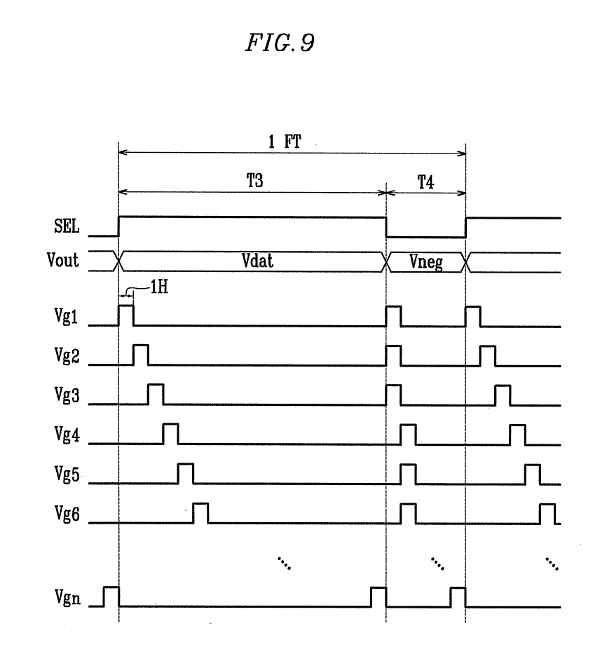

Now, an operation of the exemplary embodiment of an organic light emitting diode display according to the present invention will be described with reference to FIGS. 7 and 8.

FIG. 7 is a waveform diagram of an exemplary embodiment of the operation of an OLED display according to the present invention.

The signal controller 600 displays an image by dividing one frame 1FT into two fields T1 and T2. The signal controller 600 sets the selecting signal SEL of the first field T1 to a high level and sets the selecting signal SEL of the second field T2 to a low level.

The length of the first field T1 is one or more times that of the second field T2.

For example, a time ratio of the first and second fields T1 and T2 may be set to a ratio of n:1 (where n is an integer), and in the present exemplary embodiment, a time ratio of the first and second fields T1 and T2 is 2:1.

First, in the first field T1, the data driver 500 converts the digital image signal DAT to an analog normal data voltage Vdat and then applies the converted voltage to corresponding data lines D₁-Dₘ.

At this time, the scan driver 400 applies a high level scanning signal Vgᵢ (i=1, 2, . . . , n) to a corresponding scanning signal line Gᵢ. As the switching transistor Qs is turned on by the high level scanning signal Vgᵢ, the normal data voltage Vdat is applied to the control terminal of the driving transistor Qd and a corresponding voltage is charged to the capacitor Cst. Accordingly, the driving transistor Qd outputs a driving current I_{LD} corresponding to the normal data voltage Vdat to an anode electrode of the organic light emitting diode LD. The organic light emitting diode LD emits predetermined light depending on an amount of a driving current I_{LD}.

This operation is sequentially performed from the first pixel line to the last pixel line during the first field T1 to display one image in the display panel 300. This image may constitute one frame of the many frames which are displayed sequentially to form a motion picture.

Once the charge of a data voltage for a pixel of the last pixel line is converted to a high level scanning signal Vgₙ and is supplied to the last pixel line, the second field T2 begins.

First, the signal controller 600 lowers a voltage level of the selection signal SEL to a low level and again supplies the digital image data DAT to the data driver 500. At this time, the digital image data DAT may be equal to or proportional with the digital image data DAT in the first field T1, or alternatively may have a fixed value regardless of that of the first field T1.

Once the selection signal SEL drops to a lower level the data driver 500 converts the supplied digital image data DAT to a corresponding reverse bias voltage Vneg.

The scan driver 400 simultaneously changes a scanning signal which is applied to two scanning signal lines depending on a scan control signal CONT1 from the signal controller 600, to a high voltage Von. Such a scanning signal can be represented by adjusting the scanning start signal STV and the clock signal.

If a scanning signal which is applied to two scanning signal lines simultaneously becomes a high voltage, the switching transistor Qs which is connected to two scanning signal lines is simultaneously turned on to apply a reverse bias voltage Vneg to the control terminal of the driving transistor Qd. Accordingly, the driving transistor Qd is turned off, whereby a driving current I_{LD} is not output and thus the organic light emitting diode LD does not emit light. Accordingly, a black color is displayed on a screen of the organic light emitting diode display.

Such an operation is sequentially performed up to the last two pixel lines to display a black color in the display panel 300. If a reverse bias voltage Vneg is applied to the control terminal of the driving transistor Qd, the deterioration of the threshold voltage of the driving transistor Qd can be reduced. That is, as the driving transistor Qd is turned off by supplying the reverse bias voltage Vneg to the control terminal of the driving transistor Qd for a predetermined time, stresses associated with continuous driving of a current can be reduced or effectively eliminated.

In another exemplary embodiment a pulse width of a scanning signal in the first field T1 may be equal to that of a scanning signal in the second field T2. In such an exemplary embodiment, if a frame frequency of the input image signals R, G and B is 60 Hz (e.g., meaning that a new image is supplied every 60^{th} of a second), the signal controller 600 supplies the output digital image data DAT to the data driver 500 with a frame frequency of 120 Hz (the image is displayed for one 120^{th} of a second and a black screen is displayed for one 120^{th} of a second so that a new image and black screen combination is displayed every 60^{th} of a second).

If a period of the first field T1 and a period of the second field T2 have a ratio of 1:1, and the frame rate is 60 Hz (e.g., 16.66 ms per frame), then the first field T1 and the second field T2 are both maintained for about 8.33 ms (half of the total frame length). Because the second field T2 is maintained for half the total frame length the luminance is reduced by about 50%.

However, according to the present exemplary embodiment, wherein the ratio of T1 to T2 is 2:1, the first field T1 is maintained for 11.06 ms and the second field T2 is maintained for about 5.53 ms, thereby the decrease in luminance is about 25% compared to that of a conventional display which does not use the Vneg driving principle.

FIG. 8 is a schematic diagram illustrating an example of a screen of the exemplary embodiment of the OLED display which is displayed according to a driving method shown in FIG. 7. Specifically, the ratio of T1 to T2 is 2:1.

Referring to FIG. 8, a black color is displayed corresponding to a reverse bias voltage Vneg of a previous frame. The entire screen of an initial frame is black because the light emitting diodes of all of the pixels therein are in a non-emitting state. When the first field T1 starts, light emission is sequentially started from the top end of the screen to display an image. Therefore, in ⅓ frame, an image is displayed on the upper half of a screen and when the first field T1 ends (at ⅔ frame), an image is displayed on the entire screen.

Next, when the second field T2 is started, a black color is displayed from the top end of the screen and thus a black color is displayed on the upper half of the screen in ⅚ frame, and when the second field T2 is ended, a black color is displayed on the entire screen.

Once the normal data voltage Vdat is supplied, the pixel PX emits light until the reverse bias voltage Vneg is applied. Once the voltage Vneg is supplied, the pixel PX stays off (e.g., does not emit light) until a normal data voltage Vdat of the next frame is supplied.

Therefore, because light is not emitted during ⅓ frame of one frame 1FT, a blurring phenomenon in which an image is not clear and becomes dim due to deteriorating turn-on voltages of the driving transistor Qd can be prevented.

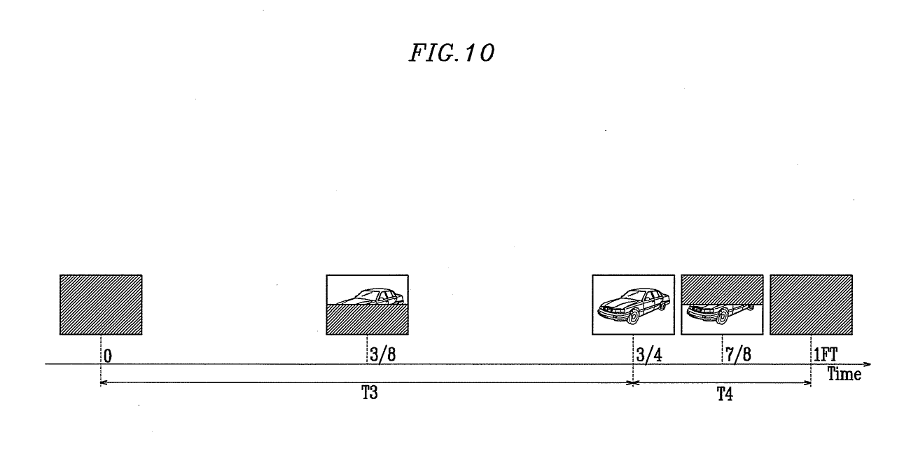

Hereinafter, an operation of the organic light emitting diode display according to another exemplary embodiment of the present invention will be described in more detail with reference to FIGS. 9 and 10.

FIG. 9 is a waveform diagram of another exemplary embodiment of the operation of an OLED display according to the present invention. FIG. 10 is a schematic diagram illustrating a screen of the exemplary embodiment of the OLED display which is displayed according to the operation illustrated in FIG. 9.

In the present exemplary embodiment, the signal controller 600 displays an image by dividing one frame 1FT into two fields T3 and T4, and displays a normal image in the first field T3 and a black image in the second field T4. However, unlike the exemplary embodiment shown in FIG. 7, times of the first field T3 and the second field T4 have a ratio of 3:1.

Therefore, when a frame frequency of the input image signals R, G and B is 60 Hz, the signal controller 600 supplies the output image data DAT to the data driver 500 with a frame frequency of 180 Hz.

In the second field T4, the scan driver 400 simultaneously changes a scanning signal which is applied to three scanning signal lines to a high voltage Von depending on a scan control signal CONT1 from the signal controller 600, whereby three pixel lines simultaneously display a black color.

Referring to FIG. 10, starting with an initial black screen, an image is displayed on the upper half of a screen in ⅜ frame, and when the first field T3 ends (at ¾ frame) an image is displayed on the entire screen. Next, when the second field T4 is started, a black color is displayed starting from the top end of the screen, whereby a black color is displayed on the upper half of the screen in ⅞ frame, and when the second field T4 is ended, a black color is displayed on the entire screen.

Therefore, according to the present invention, it is possible to supply a reverse bias voltage to a driving transistor for a predetermined time even while fully securing a light emitting time. Accordingly, it is possible to reduce or effectively prevent the deterioration of a threshold voltage of a driving transistor and to reduce a blurring phenomenon by an impulsive effect.

While the present invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. A display device comprising:
a display panel including a plurality of scanning signal lines, a plurality of data lines, and a plurality of pixels which are connected to the scanning signal lines and the data lines and which are arranged in a plurality of lines and rows to form a matrix shape, for displaying an image;
a scan driver for applying a scanning signal to the scanning signal lines; and
a data driver for generating a data voltage including a normal data voltage and a reverse bias voltage, sequentially applying the normal data voltage to substantially all of the pixels during a first period, and then applying a reverse bias voltage to substantially all of the pixels during a second period,
wherein each pixel includes
a switching transistor which is connected to one of the scanning signal lines and one of the data lines,
a driving transistor which is electrically connected with the switching transistor, and
an organic light emitting diode which is connected to the driving transistor.

2. The display device of claim 1, wherein the reverse bias voltage has a magnitude which can turn off the driving transistor.

3. The display device of claim 2, wherein the reverse bias voltage is simultaneously applied to two or more of the lines of pixels.

4. The display device of claim 3, wherein the length of the first period is one or more times that of the second period.

5. The display device of claim 4, wherein the length of the first period is a multiplied number of the length of the second period by n times wherein n is an integer.

6. The display device of claim 5, wherein the length of the first period is two times that of the second period, and the reverse bias voltage is simultaneously applied to two of the lines of pixels.

7. The display device of claim 4, wherein the length of the first period is three times that of the second period, and the reverse bias voltage is simultaneously applied to three of the lines of pixels.

8. A driving method of an organic light emitting diode display including a plurality of pixels which are arranged in a plurality of lines and rows to form a matrix shape, each pixel including a switching transistor which is connected to a scan signal line and a data line, a driving transistor which is electrically connected with the switching transistor, and an organic light emitting diode which is connected to the driving transistor, the method comprising:
sequentially applying a normal data voltage to the pixel; and
sequentially applying a reverse bias voltage to the pixel,
wherein the reverse bias voltage is simultaneously applied to two or more of the lines of pixels.

9. The driving method of claim 8, wherein the reverse bias voltage has a magnitude which can turn off the driving transistor.

10. The driving method of claim 9, wherein the length of time in which the normal data voltage is applied is one or more times the length of time in which the reverse bias voltage is applied.
